(19) United States
(12) Patent Application Publication
(10) Pub. No.: US 2025/0257876 A1
(43) Pub. Date: Aug. 14, 2025

(54) BBQ OVEN

(71) Applicant: GMG Products, LLC, Lakeside, OR (US)

(72) Inventors: David W. Baker, Lakeside, OR (US); Jason E. Baker, Scottsdale, AZ (US); Wang Ping, Wuhan (CN)

(21) Appl. No.: 19/193,749

(22) Filed: Apr. 29, 2025

Related U.S. Application Data
(63) Continuation of application No. 17/765,437, filed on Mar. 30, 2022, now Pat. No. 12,287,096.

(51) Int. Cl. F24B 1/02; A47J 36/32; A47J 37/07; F24B 5/06; F24B 13/04

(52) U.S. Cl. CPC F24B 1/028; A47J 36/32; A47J 37/0704; A47J 37/0786; F24B 5/06; F24B 13/04; A47J 2202/00

(57) ABSTRACT

The present application relates to a BBQ oven, comprising an oven, a loading container and a mixing unit. The loading container is arranged on the oven, having a loading inlet on the top and a discharge outlet at the bottom; the mixing unit includes a mixing driver positioned on the side wall of the loading container and a mixer connected to the mixing driver. The BBQ oven requires no manual turning to prevent fuel arching as the mixing unit consisting of the mixing driver and the mixer connected to the mixing driver can mix and split fuel being arched by turning of the mixer driven by the mixing driver, and thereby reduces the labor work intensity.

### PRIORITY CLAIM

This application is a continuation of U.S. patent application Ser. No. 17/765,437 filed Mar. 30, 2022; which is a U.S. National Phase of International Patent Application No. PCT/CN2022/078958 filed Mar. 3, 2022, the contents of which is incorporated herein by reference.

### FIELD OF THE INVENTION

The present invention relates to the BBQ field, in particular to a BBQ oven.

### BACKGROUND OF THE INVENTION

Existing BBQ ovens require users to successively load fuel, and thus have a hopper provided on the oven for fuel loading; during fuel loading, the fuel being load may arch to block the hopper, resulting in obstructed loading.

In the prior art, manual fuel turning is required to split arched fuel. Due to inefficiency of such manual turning, fuel arching still occurs to adversely affect fuel supply to the hearth. Besides, manual turning consumes both time and effort.

### SUMMARY OF THE INVENTION

An embodiment of the present application provides a BBQ oven to solve the problem of time-and effort-consuming constant manual turning required in the related art, by which fuel arching may still occur to adversely affect fuel supply to the hearth.

The present invention provides a BBQ oven comprising:
An oven;
A loading container which is provided on the oven. The loading container has a loading inlet on the top and a discharge outlet at the bottom;
A mixing unit which includes a mixing driver positioned on the side wall of the loading container and a mixer connected to the mixing driver.

In some embodiments, the mixer comprises a sleeve, a linking rod and a mixing rod; the sleeve is fixed on the driving shaft of the mixing driver; the linking rod is positioned inside of the sleeve; the mixing rod has one end connected flexibly to the linking rod and the other end extend beyond the side wall of the sleeve.

In some embodiments, the mixing rod has a groove on its side wall; the linking rod fits in the groove.

In some embodiments, the groove is arc-shaped.

In some embodiments, the sleeve comprises a sleeve body and a gland; the gland is arranged on the sleeve body in a removable manner; the sleeve body is concave inwards to form a chute; the linking rod is arranged flexibly in the chute.

In some embodiments, the mixing rod has hardness of above HRC 35.

In some embodiments, the present invention still comprises:
A hearth which is arranged in the oven;
A casing which is provided on the oven and communicating to the hearth. The casing has an opening that communicates to the discharge outlet;
A loading mechanism which is positioned in the casing and used for loading of the hearth;
An air supply mechanism which is positioned in the casing and used for air supply to the hearth;
A temperature sensor which is arranged on the oven and used for collecting the ambient temperature;
A controller which is connected to the temperature sensor and used for receiving the ambient temperature collected by the temperature sensor; the ambient temperature received is used for control over operation of the loading mechanism and the air supply mechanism.

In some embodiments, the loading mechanism comprises a loading driver, a feeding tube and a spiral transmission shaft; the feeding tube is positioned in the casing; the spiral transmission shaft is positioned in the feeding tube; the loading driver is connected to the spiral transmission shaft for driving;
The feeding tube has a material-receiving port and a feeding port; the material-receiving port communicates to the opening on the casing; the feeding port communicates to the hearth.

In some embodiments, the loading driver has an output shaft c; the cross section of the output shaft c has at least one straight edge d;
The BBQ oven also comprises a coupling part which is arranged on the spiral transmission shaft and used for connecting the spiral transmission shaft and the loading driver.

In some embodiments, the spiral transmission shaft has a limit slot at the inward depression on the circumference of the external wall;
The coupling part includes a bushing and a first connecting piece inserted flexibly in the bushing; the bushing is arranged on the spiral transmission shaft; when the output shaft c connects to the spiral transmission shaft, the first connecting piece runs through the bushing to the limit slot.

In some embodiments, the spiral transmission shaft has a limit collar on the side wall; when the bushing comes in contact with the limit collar, the hole on the side wall of the bushing communicates to the limit slot.

In some embodiments, the coupling part further comprises an adapter plate and a second connecting piece; the adapter plate is connected to the loading driver in a removable manner; the second connecting piece is used for fixing the adapter plate and the bushing onto the casing.

In some embodiments, the oven has a carrier rack inside; on the carrier rack is an oil plate provided; the oven has an oil plate access opening on the side wall.

In some embodiments, the carrier rack comprises a first folded plate and a second folded plate that are connected to each other; the first folded plate is fixed to the side wall of the oven; the second folded plate is positioned in the oven, and extends in the direction far away from the first folded plate to the oil plate access opening.

In some embodiments, the carrier rack also includes a third folded plate which connects the first folded plate and the second folded plate to realize indirect connection between the first folded plate and the second folded plate; the third folded plate forms an included angle with the second folded plate; the third folded plate forms a placement slot with the oven.

In some embodiments, a fire-blocking cover is provided in the hearth; the fire-blocking cover has an opening on the top, and can move along the length of the hearth;
A fire deflector is provided at the top inside the fire-blocking cover; the fire deflector has a first thermally conductive surface and a second thermally conductive surface; the first thermally conductive surface forms a first air deflector a with the hearth; the second thermally conductive surface forms a second air deflector b with the hearth; the fire-blocking cover can be moved to change the area of the first air deflector a and the second air deflector b.

In some embodiments, the fire deflectors comprise a first fire deflector and a second fire deflector; the first fire deflector, the second fire deflector and the fire-blocking cover form a space of which the cross section is shaped roughly as a isosceles triangle; the first fire deflector has the side away from the space form the first thermally conductive surface; the second fire deflector has the side away from the space form the second thermally conductive surface.

In some embodiments, the present invention comprises:
A case which is positioned on the oven and encloses the loading container;
A power source holder which is provided on the inner side wall of the case. The power source holder and the inner wall of the case form a power source containing cavity; the power source containing cavity has an opening;
A press-holding mechanism which is positioned on the side wall of the power source holder. The press-holding mechanism has one press-holding end which can move close to or away from the power source containing cavity.

In some embodiments, the press-holding mechanism includes a clip; the power source holder has one adjustable opening on the side wall; the clip is located inside of the adjustable opening; the clip has one end connect to the power source holder, and the other end act as a press-holding end.

In some embodiments, the power source holder comprises a first side plate and two second side plates; the two second side plates are arranged in a spaced manner; the second side plates connect to the side wall of the case and the first side plate; the first side plate, the second side plates and the case form the power source containing cavity.

Benefits of the technical proposal provided in the present application include:

Embodiments of the present application provide a BBQ oven which requires no manual turning to prevent fuel arching, as the mixing unit consisting of the mixing driver and the mixer connected to the mixing driver can mix and split fuel being arched by turning of the mixer driven by the mixing driver, and thereby reduces the labor work intensity.

### BRIEF DESCRIPTION OF THE DRAWINGS

Preferred and alternative examples of the present invention are described in detail below with reference to the following drawings:

To further clarify the technical proposal of the present application, a brief description of the accompanying drawings used in embodiments of the technical proposal is given. Apparently the accompanying drawings described below are non-exclusive embodiments of the present invention, and other accompanying drawings may be derived without creative effort by persons of ordinary skill in the art based on these drawings above.

FIG. 1 is an internal structure view of the BBQ oven provided in accordance with an embodiment of the present application;

FIG. 2 is an internal structure view of the loading container provided in accordance with an embodiment of the present application;

FIG. 3 is an internal structure view of the mixing driver provided in accordance with an embodiment of the present application;

FIG. 4 is the side view of the connected linking rod and mixing rod in accordance with an embodiment of the present application;

FIG. 5 is an internal structure view of the BBQ oven provided in accordance with an embodiment of the present application;

FIG. 6 is the sectional view of the loading unit provided in accordance with an embodiment of the present application;

FIG. 7 is the sectional view of the output shaft provided in accordance with an embodiment of the present application;

FIG. 8 is a structural view of the carrier rack provided in accordance with an embodiment of the present application;

FIG. 9 is a structural view of the fire-blocking cover provided in accordance with an embodiment of the present application;

FIG. 10 is a structural view of the power source holder provided in accordance with an embodiment of the present application;

FIG. 11 is an amplified view of the structural point A in FIG. 10.

FIG. 12 is a structural view of the oil plate provided in accordance with an embodiment of the present application.

In the drawings: 1. Oven; 2. Loading container; 3. Loading inlet; 4. Discharge outlet; 5. Mixing unit; 51. Mixing driver; 52. Mixer; 521. Sleeve; 5211 Sleeve body; 5212. Gland; 522. Linking rod; 523. Mixing rod; 6. Groove; 7. Chute; 8. Hearth; 9. Loading mechanism; 91. Loading driver; 92. Feeding tube; 93. Spiral transmission shaft; 10. Air supply mechanism; 20. Casing; 30. Output shaft; 301. Bushing; 302. First connecting piece; 303. Adapter plate; 40. Limit slot; 50. Limit collar; 60. Carrier rack; 601. First folded plate; 602. Second folded plate; 603. Third folded plate; 70. Oil plate; 701. Base plate; 702. Limit plate; 703. Turned edge; 80. Oil plate access opening; 90. Placement slot; 100. Oil guide; 1001. Oil guide inlet; 1002. Oil guide outlet; 200. Case; 300. Power source holder; 3001 First side plate; 3002. Second side plates; 400. Power source containing cavity; 500. Press-holding mechanism; 600. Adjustable opening; 700. Fire-blocking cover; 800. Fire deflectors; 8001. First fire deflector; 8002 Second fire deflector; 900. First thermally conductive surface; 1000. Second thermally conductive surface; a. First air deflector; b. Second air deflector; c. Output shaft; d. Straight edge.

### DETAILED DESCRIPTION OF THE PREFERRED EMBODIMENT

To further clarify the objects, technical proposal and advantages of embodiments in accordance with the present application, a clear and complete description of the technical proposal in the embodiments of the present application is given below in combination with the accompanying drawings of the embodiments. Apparently the embodiments described above are demonstrative other than exclusive. All other embodiments derived without creative effort by persons of ordinary skill in the art based on the embodiments of the present application are covered by the present invention defined by the claims.

To solve the problems described above, reference is made to the accompanying drawings 1-12. The present application discloses a BBQ oven which provides a solution to the problem of time-and effort-consuming constant manual turning required in the related art, by which fuel arching may still occur to adversely affect fuel supply to the hearth.

The present application provides a BBQ oven, comprising an oven 1, a loading container 2 and a mixing unit 5. The loading container 2 is provided on the oven 1, having a loading inlet 3 on the top and a discharge outlet 4 at the bottom; the mixing unit 5 includes a mixing driver 51 provided on the side wall of the loading container 2 and a mixer 52 connected to the mixing driver 51.

In the present application, as shown in FIG. 1, the cross section of the loading container 2 is right trapezoid-shaped. For convenient loading, the loading inlet 3 has a wide opening, and the discharge outlet 4 has a narrow opening; the mixing driver 51 and the mixer 52 are both provided on the inclined side wall of the loading container 2; the rotation shaft of the mixing driver rotates in parallel to the inclined side wall; when “arching” (namely material accumulation) occurs, the mixing driver 51 will drive the mixer 52 to move the material, so as to realize arching interruption.

Further, the mixer 52 comprises a sleeve 521, a linking rod 522 and a mixing rod 523; the sleeve 521 is fixed on the driving shaft of the mixing driver 51; the linking rod 522 is provided inside of the sleeve 521; the mixing rod 523 has one end connected flexibly to the linking rod 522 and the other end extend beyond the side wall of the sleeve 521.

In the present application, the mixing driver 51 is preferably a mixing motor available on the market; when the mixing motor drives the drive shaft, the sleeve 521 will be driven along to realize rotation of the mixing rod 523; as the mixing rod 523 is connected to the linking rod 522, it can be understood that the mixing rod can move in two perpendicular directions; compared with the conventional movement in one direction, the mixing rod 523 in the present application has a wider range of movement to realize better “arching interruption”.

Based on the embodiment above, to realize rotation, the mixing rod 523 has a groove 6 on the side wall; the linking rod 522 fits the groove 6.

As shown in FIG. 4, the mixing rod 523 can rotate in the groove 6; for smooth and stable rotation of the linking rod 522, the groove 6 is arc-shaped.

In the present application, for convenient arrangement and detachment, the sleeve 521 comprises a sleeve body 5211 and a gland 5212; the gland 5212 is provided on the sleeve body 5211 in a removable manner, specifically by use of screw or bolt connection; the sleeve body 5211 sinks inwards to form a chute 7; the linking rod 522 is arranged flexibly in the chute 7.

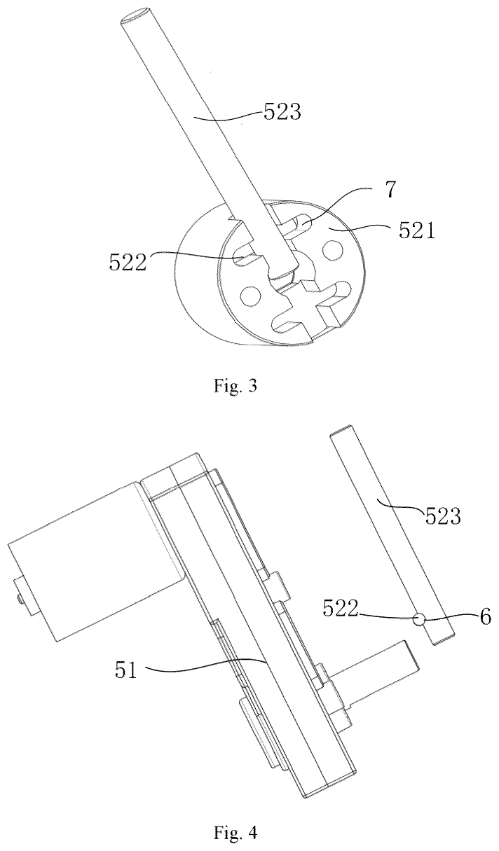

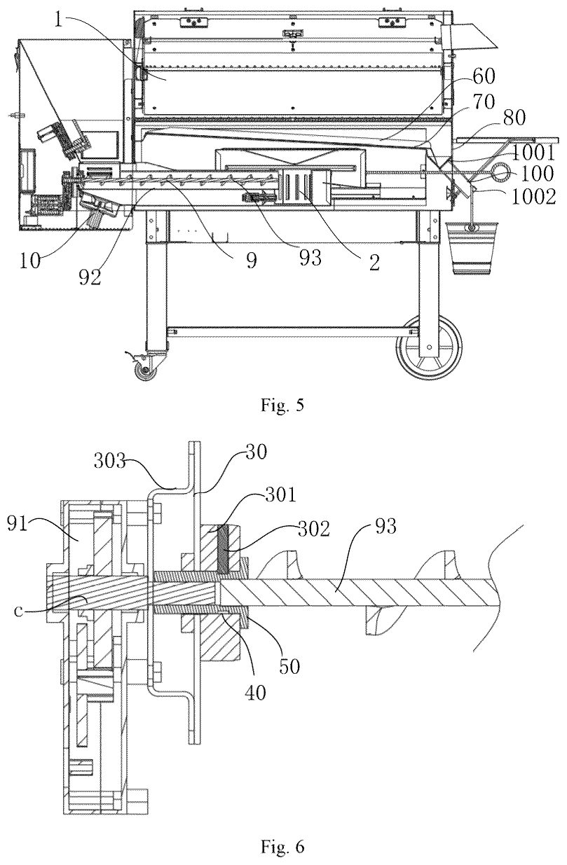

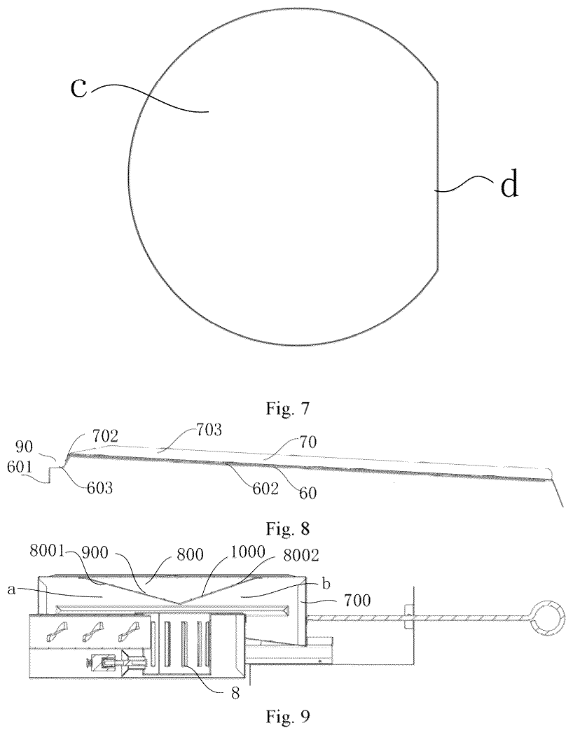

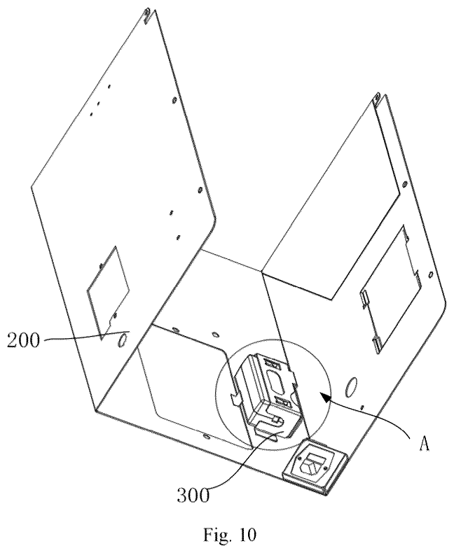

As shown in FIG. 3, if the linking rod 522 is fixed, then the rotating range of the mixing rod 523 is also fixed; to enlarge the rotating range of the mixing rod 523, the linking rod 522 is flexibly provided in the chute 7. As the chute 7 has both sides arranged close to the linking rod, its moving range is limited. Therefore, in the present application, the linking rod 522 mainly moves from the top opening to the bottom of the chute, or from the bottom to the top opening of the chute; as the linking rod 522 is movable, the rotating range of the mixing rod 523 is enlarged, which may help split “arched” material.

The linking rod 522 is movable, and thus can move when the mixing driver 51 rotates. It should be understood that when the linking rod 522 is located at the chute bottom and the mixing rod 523 fits the gland 5212, the linking rod 522 should have a part remain in the groove 6 to prevent the mixing rod 523 from fall from the sleeve body 5211.

Further, considering frequent collision between the mixing rod 523 frequently collides and the linking rod 522, the mixing rod 523 should have hardness of above HRC 35.

Further, the BBQ oven according to the application still comprises a hearth 8, a casing 20, a loading mechanism 9, an air supply mechanism 10, a temperature sensor (not shown in the figure) and a controller (not shown in the figure).

The oven 1 has a hearth 8 inside; the loading mechanism 9 is provided in the casing 20 and used for loading the hearth 8; the air supply mechanism 10 is provided in the casing 20, and used for supplying air to the hearth 8; the temperature sensor is provided on the oven 1, and used for collecting the ambient temperature; the controller connected with the temperature sensor is used for controlling operations of the loading mechanism 9 and the air supply mechanism 10 based on the ambient temperature received from the temperature sensor.

In the present application, the loading mechanism 9 adopts a spiral transmission shaft and is driven by a motor, with a controller connected to the motor signal to control the rotating speed of the motor; the air supply mechanism 10 adopts a fan currently available on the market, with a controller connected to the motor signal to control the rotating speed of the fan; a controller connecting to the motor and a controller connecting to a fan described above are present in prior art, and thus no further explanation will be given.

During specific implementation, the temperature sensor collects the ambient temperature. For example, when low ambient temperature data collected in winter is transmitted to the controllers, the controllers will control the loading mechanism 9 to load more fuel and control the air supply mechanism 10 to supply more air; when high ambient temperature data collected in summer is transmitted to the controllers, the controllers will control the loading mechanism 9 to reduce loading and control the air supply mechanism 10 to reduce air supply.

Based on the embodiment described above, the loading mechanism 9 comprises a loading driver 91, a feeding tube 92 and a spiral transmission shaft 93; the feeding tube 92 is provided in the casing 20; the spiral transmission shaft 93 is provided in the feeding tube 92; the loading driver 91 is connected to the spiral transmission shaft 93 for driving;

The feeding tube 92 has a material-receiving port and a feeding port; the material-receiving port communicates to the opening on the casing 20; the feeding port communicates to the hearth 8.

The loading driver 91 adopts a motor driving the spiral transmission shaft 93 to rotate, in realization of material transport.

Further, the loading driver has an output shaft c; the cross section of the output shaft c has at least one straight edge d;

The BBQ oven also comprises a coupling part 30 which is provided on the spiral transmission shaft 93 and used for connecting the spiral transmission shaft 93 and the loading driver 91.

In conventional solutions, the feeding screw head and the feeding motor output shaft are connected via drive pins or screws; pins and screws have limited load-bearing capacity, and are prone to shear fracture due to fatigue. In the present application, the cross section of the output shaft c has a straight edge d which can largely increase the torque compared with the conventional use of pin or screw transmission. It is understood that two or three straight edges d may well be provided to increase the torque; on the other hand, the coupling part 5 in the present application may connect the spiral transmission shaft 4 and the driver 1 to prevent separation of the spiral transmission shaft 4 from the output shaft 2.

Further, the spiral transmission shaft 93 has a limit slot 40 at the inward depression on the circumference of the external wall;

The coupling part 30 includes a bushing 301 and a first connecting piece 302 inserted flexibly in the bushing 301; the bushing 301 is arranged on the spiral transmission shaft 93; when the output shaft c connects to the spiral transmission shaft 93, the first connecting piece 302 runs through the bushing 301 to the limit slot 40; the first connecting piece 302 is a rod piece, and a pin or other connecting piece alike can be used.

The bushing 301 is provided on the spiral transmission shaft 93; the bushing 301 has a hole, through which the first connecting piece 302 can run through and extend to the limit slot 40; the limit slot 40 is a circular slot, and therefore can limit the axial movement of the spiral transmission shaft 93 when the bushing 301 connects to the loading driver 91; as the limit slot 40 is circular, rotation of the output shaft c can drive rotation of the spiral transmission shaft 93; in the present application, the first connecting piece 302 is preferably a rod piece; this design provides convenience for replacement and maintenance of the spiral transmission shaft 93.

Based on the embodiment described above, for accurate insertion of the first connecting piece 302 into the limit slot 40 when the bushing 301 is run onto the spiral transmission shaft 93, the spiral transmission shaft 93 has a limit collar 50 on the side wall; when the bushing 301 presses against the limit collar 50, the opening on the side wall of the bushing 301 communicates to the limit slot 40.

In the present application, the limit collar 50 is circular. It can be certainly understood that the limit collar 50 can be block-shaped or of other irregular shape, provided the protruding spiral transmission shaft 93 can be set.

Further, the coupling part 30 also comprises an adapter plate 303 and a second connecting piece; the adapter plate 303 is connected to the loading driver 91 in a removable manner; the second connecting piece is used for fixing the adapter plate 303 and the bushing 301 onto the casing 20.

For easy fixation of the loading driver 91 and the bushing 301, the coupling part 30 described in the present application still comprises an adapter plate 303 and a second connecting piece; the adapter plate 303 is connected to the driver 1 in a removable manner; the second connecting piece is used for fixing the adapter plate 303 and the bushing 301 to the feeding tube 92.

The second connecting piece is preferably a screw, a bolt or other removable connecting piece.

Further, in the present application, the oven 1 has a carrier rack 60 inside; on the carrier rack 60 is an oil plate 70 provided; the oven 1 has an oil plate access opening 80 on the side wall.

In the present application, the oil plate 70 collects oil falling from the grates; as the oil plate 70 is erected on the carrier rack 60, and the oven 1 has an oil plate access opening on the side wall, the user can easily take out the oil plate 70 via the oil plate access opening 80 for cleaning, so as to prevent long-time accumulation of greasy dirt.

Specifically, the carrier rack 60 comprises a first folded plate 601 and a second folded plate 602 that are connected to each other; the first folded plate 601 is fixed to the side wall of the oven 1; the second folded plate 602 is provided in the oven 1, and extends in the direction far away from the first folded plate 601 to the oil plate access opening 80.

Specifically, the carrier rack 60 also includes a third folded plate 603; the third folded plate connects the first folded plate 601 and the second folded plate 602 to realize indirect connection between the first folded plate 601 and the second folded plate 602; an included angle is formed between the third folded plate 603 and the second folded plate 602; a placement slot 90 is formed between the third folded plate 603 forms and the oven 1.

For position limit, the oil plate 70 comprises a base plate 701 and a limit plate 702 that are mutually connected; the limit plate 702 is provided at the end of the base plate 701 far away from the oil plate access opening, so that when the base plate 701 is placed on the third folded plate 603, the limit plate 702 is located in the placement slot 90 and presses against the third folded plate 603.

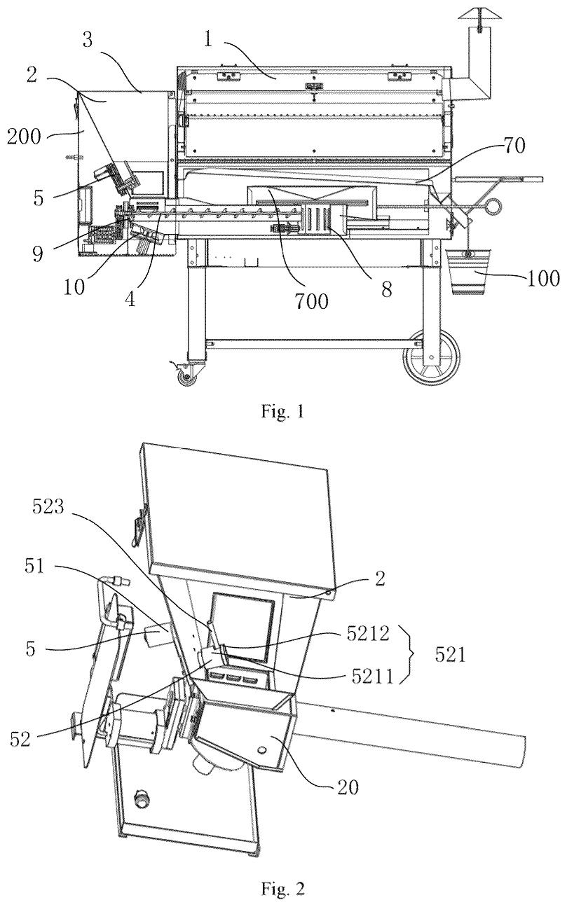

As shown in FIG. 2, when the limit plate 702 contacts the third folded plate 603, the third folded plate 603 will press against the limit plate 702 to prevent fall of the oil plate 70 from the carrier rack 60.

In the present application, for easy drip of oil from the oil plate 70, the whole base plate 701 and the second folded plate 602 are arranged inclined, and the second folded plate 602 has the end close to the third folded plate 603 higher than the other end; therefore, in the present application, the placement slot (90) formed between the third folded plate 603 and the oven 1 can contain the limit plate 702 when the oil plate 70 is set in place.

To prevent oil splash, the base plate 701 has both sides extend upwards with turned edges 703 along the length of the base plate 701; the length of the turned edges 703 can be set as appropriate.

For guiding oil out of the oven 1, an oil guide 100 is provided on the oven 1; the oil guide 100 has an oil guide inlet 1001 at one end, and an oil guide outlet 1002 at the other end; the oil guide 100 is arranged inclined; the oil guide inlet 1001 is located below the oil plate 70, and is used for collecting oil guided out by the oil plate 70; the oil guide inlet 1001 is higher than the oil guide outlet 1002.

In the present application, the BBQ oven still comprises a fire-blocking cover 700 and fire deflectors 800; the fire-blocking cover 700 provided on the hearth 8 has an opening on the top and can move along its length relative to the hearth 8; the fire deflectors 800 provided on the top inside the fire-blocking cover 700 have the first thermally conductive surface 900 and the second thermally conductive surface 1000; the first thermally conductive surface 900 forms a first air deflector a with the hearth 8; the second thermally conductive surface 1000 forms a second air deflector b with the hearth 8; the fire-blocking cover 700 can move to adjust the area of the first air deflector a and the second air deflector b.

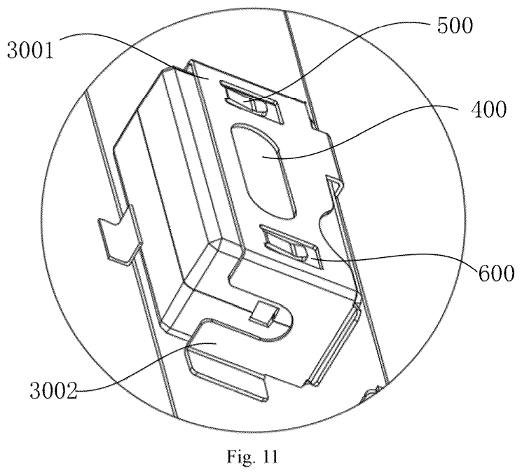

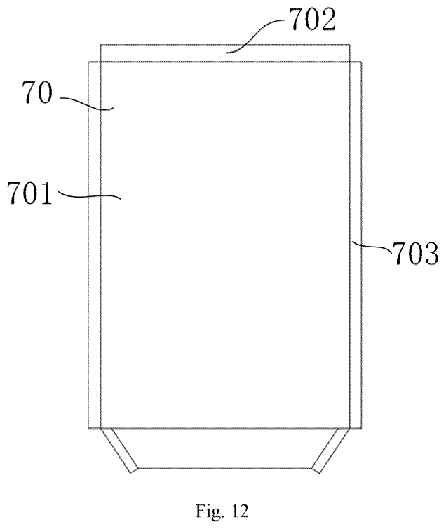

During specific implementation, as shown in FIG. 9, heat produced in the hearth 8 dissipates through the second air deflector b, the first air deflector a and the opening on the top of the fire-blocking cover 700; when it is only required to heat the right side of the grates, it is simply needed to move the fire-blocking cover 700 leftwards; at this time, heat will mainly dissipate along the second thermally conductive surface 1000, and relatively less heat will dissipate via the first air deflector a due to the reduced area; therefore, movement of the fire-blocking cover 700 can change the area of the first air deflector a and the second air deflector b to meet the searing needs at different parts, so as to prevent waste of resources.

Further, in the present application, the fire deflectors 800 comprise a first fire deflector 8001 and a second fire deflector 8002; the first fire deflector 8001, the second fire deflector 8002 and the fire-blocking cover 700 form a space of which the cross section is shaped roughly as a isosceles triangle; the first fire deflector 8001 has the side away from the space form the first thermally conductive surface 900; the second fire deflector 8002 has the side away from the space form the second thermally conductive surface 1000.

Further, the BBQ over according to the present application still comprises a case 200, a power source holder 300 and a press-holding mechanism 500; the case 200 is arranged on the oven 1 and encloses the loading container 2; the power source holder 300 is arranged on the inner side wall of the case 200; inner walls of the power source holder 300 and the case 200 enclose to form a power source containing cavity 400; the power source containing cavity has an opening; the press-holding mechanism 500 is provided on the side wall of the power source holder 300; the press-holding mechanism 500 has a press-holding end which can move close to or away from the power source containing cavity 400.

As shown in FIG. 10 and FIG. 11, in the present application, the power source holder 300 is provided on the inner side wall of the case 200; the inner side walls of the power source holder 300 and the case 200 enclose to form the power source containing cavity 400; therefore, the power source can be placed in the power source containing cavity 400 other than outside of the oven, thereby having reduced the risk of damage.

On the other hand, as the power source holder 300 has a press-holding mechanism 500 provided on the side wall, and the press-holding mechanism 500 has a press-holding end that can move close to or away from the power source containing cavity 400, when the power source is placed in the power source containing cavity 300, the press-holding end moves close to the power source containing cavity 400 to hold the power source; when the press-holding end moves away, the power source is removed from the power source containing cavity 400.

Based on the embodiment described above, the press-holding mechanism 500 includes a clip; the power source holder 300 has one adjustable opening 600 on the side wall; the clip is located inside of the adjustable opening 600; the clip has one end connect to the power source holder 300, and the other end act as a press-holding end.

When the chip is free, the press-holding end is located in the power source containing cavity 400. As shown in FIG. 11, the press-holding end of the chip is far away from the opening end of the power source containing cavity 400, and turning of the far-away end and the end connecting to the power source holder 300 makes an easy access for the power source; when the power source is placed in the power source containing cavity 400, the press-holding end of the chip will press the power source to prevent the power source falling.

As shown in FIG. 11, the power source holder 300 comprises a first side plate 3001 and two second side plates 3002; the two second side plates 3002 are arranged in a spaced manner; the second side plates 3002 connect to the side wall of the case 200 and the first side plate 3001; the first side plate 3001, the second side plates 3002 and the case 200 form the power source containing cavity 400.

Further, to make maintenance of the BBQ oven and replacement of the power source easy, the case 200 has an access panel on the side wall; the access panel is provided on the case 200 in a removable manner by using screws or otherwise according to prior art.

Surely to further protect the power source and prevent the power source falling, the access panel is provided with a press-holding plate on one side in the case 200; when the access panel is positioned on the case 200, the press-holding plate will press against the power source and prevent the power source from falling; the press-holding plate is not limited in shape, and can be provided based on the actual conditions.

In the description of the application, it should be noted that words indicating directions or relative positions, such as “up” and “down”, are only used for convenience of description and simplified description of the application, other than for indicating or implying the specific position of a device or element, or the specific way of constructing and operating such device or element, and shall by no means be taken to limit the application. Unless otherwise expressly provided and defined, terms such as “arrangement”, “linking” and “connection” should be broadly interpreted. For example, a connection can be a fixed connection, a detachable connection or an integrated connection; a mechanical connection or an electrical connection; a direct connection, an indirect connection via an intermediate medium; or internal communication between two elements. It is required that persons of ordinary skill in the art should understand the specific meanings of the terms above in the present application based on specific circumstances.

It should be noted that, in the present application, words indicating relations such as “first” and “second” are simply used for distinguishing one entity or operation from another entity or operation, without necessarily requiring or implying any actual relationship or sequence between these entities or operations. Besides, words like “include”, “comprise” or any other variants of the foregoing should be non-exclusive. Namely, any process, method, item or equipment comprising a series of elements comprises not only such elements, but also other elements that are not expressly listed or inherent elements of such process, method, item or equipment. Unless otherwise limited, an element defined by the statement “comprising a/an . . . ” does not preclude inclusion of other similar elements in the process, method, item or equipment of the element.

All the specific ways of implementing the present application described above are intended to make those skilled in the art understand or realize the present application. These embodiments may have various modifications and alterations apparent to those skilled in the art, and the general principle defined herein may be realized in other embodiments without departing from spirit and scope of the application. For this purpose, the present application is not limited to the embodiments provided herein, and should include the widest scope of consistency with the principle and novel features of the present invention.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. A BBQ oven, comprising:
an oven;
a loading container which is arranged on the oven, wherein the loading container has a loading inlet on the top and a discharge outlet at the bottom; and
a mixing unit comprising:
a mixing driver having a driving shaft and positioned on a wall of the loading container; and
a mixer connected to the mixing driver, wherein the mixer comprises:
a mixing rod having a groove and one end extending beyond a side wall of the sleeve; and
a linking rod configured to fit in the groove of the mixing rod.

2. The BBQ oven of claim 1, further comprising a sleeve fixed on the driving shaft of the mixing drive, and wherein the linking rod is arranged inside the sleeve.

3. The BBQ oven of claim 1, wherein the groove is arc shaped.

4. The BBQ oven of claim 1, wherein:
the sleeve comprises a sleeve body and a gland;
the gland is positioned on the sleeve body in a removable manner;
the sleeve body is concave inwards to form a chute, and
the linking rod is arranged flexibly in the chute.

5. The BBQ oven of claim 1, wherein the mixing rod has hardness of above HRC 35.

6. The BBQ oven of claim 1, wherein the oven has a carrier rack configured as an oil plate and an oil plate access opening.

7. The BBQ oven of claim 6, wherein the carrier rack comprises a first folded plate and a second folded plate that are connected to each other, wherein the first folded plate is fixed to the side wall of the oven and the second folded plate is positioned in the oven and extends in the direction far away from the first folded plate towards the oil plate access opening.

8. A BBQ oven, comprising:
an oven having a hearth;
a casing provided on the oven and communicating with the hearth, the casing having an opening that communicates with the discharge outlet;
a loading mechanism positioned in the casing and used for loading of the hearth, the loading mechanism comprising:
a feeding tube positioned in the casing and having a spiral transmission shaft with a limit slot at an inward depression on the circumference of an external wall, wherein the feeding tube has a material-receiving port and a feeding port, wherein the material-receiving port communicates to the opening on the casing and the feeding port communicates to the hearth; and
a loading driver connected to the spiral transmission shaft for driving, the loading driver comprising:
an output shaft with a cross section of at least one straight edge; and
a coupling part arranged on the spiral transmission shaft and used for connecting the spiral transmission shaft and the loading driver; and
an air supply mechanism that is positioned in the casing and used for air supply to the hearth;
a temperature sensor which is arranged on the oven and used for collecting the ambient temperature; and
a controller which is connected to the temperature sensor and used for receiving ambient temperature collected by the temperature sensor, so as to control operation of the loading mechanism and the air supply mechanism.

9. The BBQ oven of claim 8, wherein
the coupling part includes a bushing and a first connecting piece inserted flexibly in the bushing; and
the bushing is arranged on the spiral transmission shaft and the first connecting piece runs through the bushing to the limit slot when the output shaft connects to the spiral transmission shaft.

10. The BBQ oven of claim 8, further comprising:
a loading container that is arranged on the oven, wherein the loading container has a loading inlet on the top and a discharge outlet at the bottom; and
a mixing unit that includes a mixing driver positioned on a wall of the loading container and a mixer connected to the mixing driver.

11. The BBQ oven of claim 8, wherein the spiral transmission shaft has a limit collar on the wall, and a hole on a wall of the bushing communicates to the limit slot when the bushing comes in contact with the limit collar.

12. The BBQ oven of claim 8, wherein the coupling part further comprises an adapter plate and a second connecting piece, wherein the adapter plate is connected to the loading driver in a removable manner and the second connecting piece is used for fixing the adapter plate and the bushing onto the casing.

13. A BBQ oven, comprising:
an oven;
a carrier rack configured as an oil plate and having an oil plate access opening on a side wall, wherein the carrier rack comprises:
a first folded plate fixed to a side wall of the oven;
a second folded plate positioned in the oven and extending in a direction away from the first folded plate towards the oil plate access opening; and
a third folded plate connecting the first folded plate and the second folded plate to realize indirect connection between the first folded plate and the second folded plate, wherein an angle is formed between the second and third folded plates and a placement slot is formed between the third folded plate and the oven.

14. The BBQ oven of claim 13, further comprising:
a loading container that is arranged on the oven, wherein the loading container has a loading inlet on the top and a discharge outlet at the bottom; and
a mixing unit that includes a mixing driver positioned on a wall of the loading container and a mixer connected to the mixing driver.

15. The BBQ oven of claim 13, further comprising:
a fire-blocking cover having an opening on the top and configured to move along the length of the hearth; and
a first fire deflector at the top inside the fire-blocking cover, the first fire deflector having a first thermally conductive surface that forms a first air deflector with the hearth, and a second thermally conductive surface that forms a second air deflector with the hearth, wherein the fire-blocking cover is configured moveable to change the area of the first air deflector and the second air deflector.

16. The BBQ oven of claim 15, further comprising a second fire deflector, wherein:
the first fire deflector, the second fire deflector and the fire-blocking cover form a space of which the cross section is shaped roughly as an isosceles triangle;
the first fire deflector has a side away from the space which forms the first thermally conductive surface; and
the second fire deflector has a side away from the space that forms the second thermally conductive surface.

17. A BBQ oven, comprising:
an oven;
a loading container which is arranged on the oven, wherein the loading container has a loading inlet on the top and a discharge outlet at the bottom;
a case provided on the oven and enclosing the loading container;
a power source holder having an adjustable opening arranged on a wall of the case, wherein the power source holder and the wall form a power source containing cavity having an opening; and
a press-holding mechanism arranged on the wall of the power source holder, wherein the press-holding mechanism has one press-holding end that can move close to or away from the power source containing cavity, the press-holding mechanism having a clip positioned inside of the adjustable opening, the clip having one end connected to the power source holder and the other end acting as a press-holding end.

18. The BBQ oven of claim 17, further comprising a mixing unit which includes a mixing driver positioned on a wall of the loading container and a mixer connected to the mixing driver.

19. The BBQ oven of claim 17, wherein:
the power source holder comprises a first side plate and two second side plates;
the second side plates are arranged in a spaced manner, wherein the second side plates connect to a side wall of the case and the first side plate; and
the first side plate, the second side plates and the case form the power source containing cavity.
